(19) United States
(12) Patent Application Publication
(10) Pub. No.: US 2010/0214265 A1
(43) Pub. Date: Aug. 26, 2010

(54) TOUCH SENSITIVE INPUT DEVICE

(76) Inventor: Shek-Wai NG, Hong Kong SAR (CN)

Correspondence Address: SHEK-WAI NG, 2/F, DAN SING LIFE BLDG., 99 DES VOEUX RD. CENTRAL, HONG KONG SAR, CN

(21) Appl. No.: 12/711,295

(22) Filed: Feb. 24, 2010

Related U.S. Application Data
(60) Provisional application No. 61/155,521, filed on Feb. 26, 2009.
(60) Provisional application No. 61/162,735, filed on Mar. 24, 2009.
(60) Provisional application No. 61/224,070, filed on Jul. 9, 2009.

(51) Int. Cl. G06F 3/045

(52) U.S. Cl. 345/174; 178/18.06

(57) ABSTRACT

The power source of back lighting device, e.g. a fluorescent lamp, inside typical electronic products is a high voltage and high frequency signal. This invention makes use of this characteristic to provide a low cost touch input device. The characteristic allows the signal to penetrate thick dielectric layers, e.g. a glass plate or the casing, to trigger a sensing circuit. Thus, the sensing circuit can be a simple logic gate and the implementation cost is low.

### FIELD OF INVENTION

This invention relates to the field of touch input devices.

### BACKGROUND OF INVENTION

There are many kinds of touch input devices. However, their working principles and costs are quite different. Touch control switches used in controlling lighting make use of the AC mains and the cost is the lowest. However, it is only workable on devices connected to the AC mains. Furthermore, this method works best when there is direct contact between the sensing electrode and a human finger.

Portable electronic products powered by battery use capacitive or resistive touch input devices. A resistive input device uses an expensive touch panel and calculates the touch position by using the resistance between edges of the panel and the touch point. However, the low transparency of the panel is a disadvantage.

A capacitive input device uses complex circuitry to detect the change in grounding capacitance when a finger is in the proximity of a sensing electrode. In U.S. Pat. No. 3,971,013, U.S. Pat. No. 4,290,061, and U.S. Pat. No. 5,572,205, there is a high voltage electric field nearby the sensing electrode. Normally, the sensing electrode picks up a high level voltage from the electric field near by. When a finger is in the proximity of the sensing electrode, the extra grounding capacitance of the human body grounded the electric field such that there is a drop in the sensed voltage. This drop in voltage is sensed as the presence of a human finger. Relatively simple circuit can be used to detect the change. However, parasitic capacitance has significant effect on the sensitivity and may lead to false trigger.

In U.S. Pat. No. 6,466,036, the grounding capacitance of a human body is measured directly. This invention does not rely on the presence of a high voltage field nearby. But the high sensitivity of the sensing electronics means this method works best on LED backlight products. Products which use a fluorescent lamp as backlight have to overcome the interference comes from the high voltage AC power source of the fluorescent lamp.

In U.S. Pat. No. 4,740,781, the construction of the touch panel is similar to a resistive input device. There is an air gap between the sensing surface and the LCD panel. When the sensing surface is pressed down to touch on the LCD panel, the line driving signal of the panel is capacitively coupled to the sensing surface. Then the electronics detects a rise in signal level. This invention has the same drawback like a resistive touch panel.

A common drawback of all existing capacitive input devices is that the dielectric media between the sensing electrode and the human finger must be thin. Otherwise, the grounding human body capacitance becomes too small to differentiate it from the stay capacitance. This invention teaches a capacitive touch input device which works with thick dielectric media but which is still low cost like the AC mains approach.

### SUMMARY OF INVENTION

Accordingly, an object of the present invention is to provide a low cost touch input device. The difficulty associated with capacitive touch input devices is that the capacitance between a human finger and the sensing electrode is very small. However, we may make use of the principle that the impedance of a capacitor decreases with the frequency of the signal across the capacitor. If there is a signal whose magnitude is comparable to the AC mains but has a higher frequency, we may have a low cost touch input device whose cost is comparable to those used for lighting control.

Many electronic products have a display, e.g. LCD, which requires a high voltage and high frequency power source to drive a back lighting device, e.g. a fluorescent lamp or a series of LEDs. By making use of this build-in high voltage and high frequency source, a sensitive and low cost touch control switch can be provided. The high voltage and high frequency AC driving signal is connected to one of a pair of electrodes and acts as the sourcing electrode. The other electrode is used as a sensing electrode. Because of the high voltage and high frequency characteristic of the driving signal, the pair of electrodes can be buried deep under thick dielectric material. When human fingers touch on the surfaces of the dielectric material above the pair of electrodes at the same time, the human body forms a conductive path. Electronics connected to the sensing electrode generates a control signal which signals human fingers are in the proximity of the sourcing and sensing electrode.

Because of the high penetration power of the high voltage and high frequency AC source signal, the sensed voltage on the sensing electrode is high. Thus, no special circuit is needed to detect the sensed voltage. The sensing electrode can be connected directly to a logic input. The touch condition can be sensed as either a logic low or logic high. Therefore, the cost of implementation of this invention is nearly zero.

In the case that the back light does not use high voltage, one may still use a simple oscillator to generate the needed high voltage and high frequency signal. Since the output current needed is in micro ampere range, the oscillator can be very simple. The implementation still can be very low cost.

These and other objects and advantages of the present invention will become clear to those skilled in the art in view of the description of the best presently known mode of carrying out the invention and the industrial applicability of the preferred embodiment as described herein and as illustrated in the several figures of the drawings.

### BRIEF DESCRIPTION OF DRAWINGS

FIG. 1a is the first embodiment in accordance with the present invention when the back light is a fluorescent lamp.

FIG. 1b is the second embodiment in accordance with the present invention when the back light is a series of LEDs.

FIG. 1c is the third embodiment in accordance with the present invention when the high voltage and high frequency power source is a stand-alone oscillator.

FIG. 2 is the electrical model of the embodiment in FIG. 1a.

FIG. 3 illustrates the use of multiple sensing electrodes to generate binary control signals.

FIG. 4 illustrates still another pattern to generate binary control signals.

FIG. 5a is the fourth embodiment in accordance with the present invention where the x-y coordinate of the touch is sensed.

FIGS. 5b-5c illustrate how to estimate the x-y coordinate of the touch position in FIG. 5a.

### DETAIL DESCRIPTION OF THE PREFERRED EMBODIMENT

The invention will now be described by the following embodiments. These embodiments are not intended to limit the scope of the present invention but are to demonstrate the invention only. All features and combinations described in the embodiments are not necessarily essential to the invention.

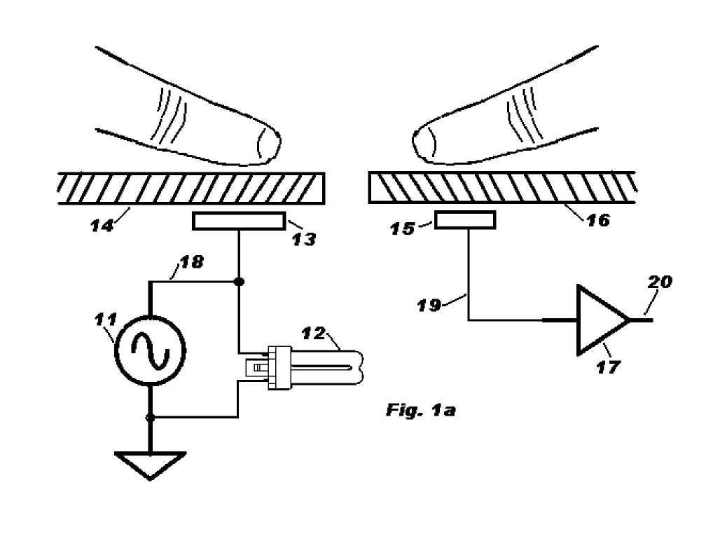

The preferred embodiments of the present invention and their advantages are best understood by referring to FIGS. 1-5c of the drawings. Like numerals are used for like and corresponding parts of the various drawings.

FIG. 1a illustrates an embodiment of the present invention when the electronic apparatus under control is equipped with a fluorescent lamp 12. The powers source 11 is a high voltage and high frequency signal. The typical voltage is 400V peak and the typical frequency is 75 kHz. This signal 18 is connected to the sourcing plate 13 which is mounted under a dielectric layer 14. On the other side of FIG. 1a is a sensing electrode 15 which is also mounted under another dielectric layer 16. The sensing circuit 17 converts the sensed signal 19 at the sensing electrode to a control signal 20.

FIG. 1b illustrates an embodiment of the present invention when the electronic apparatus under control uses a series of LEDs to provide the back light. The high voltage comes from the boost inverter. A RLC circuit which is designed to resonant at the switching frequency of the boost inverter converts the switched signal 101 to high voltage signal 18. The switched signal 101 has a typical peak of 10-15 volts and a typical frequency of 500 KHz-1 MHz. The converted high voltage signal 18 has a typical peak above 70 volts.

FIG. 1c illustrates an embodiment of the present invention when the electronic apparatus uses a stand-alone oscillator, e.g. an EL inverter, to provide the high voltage and high frequency signal 18. The extra cost is still low.

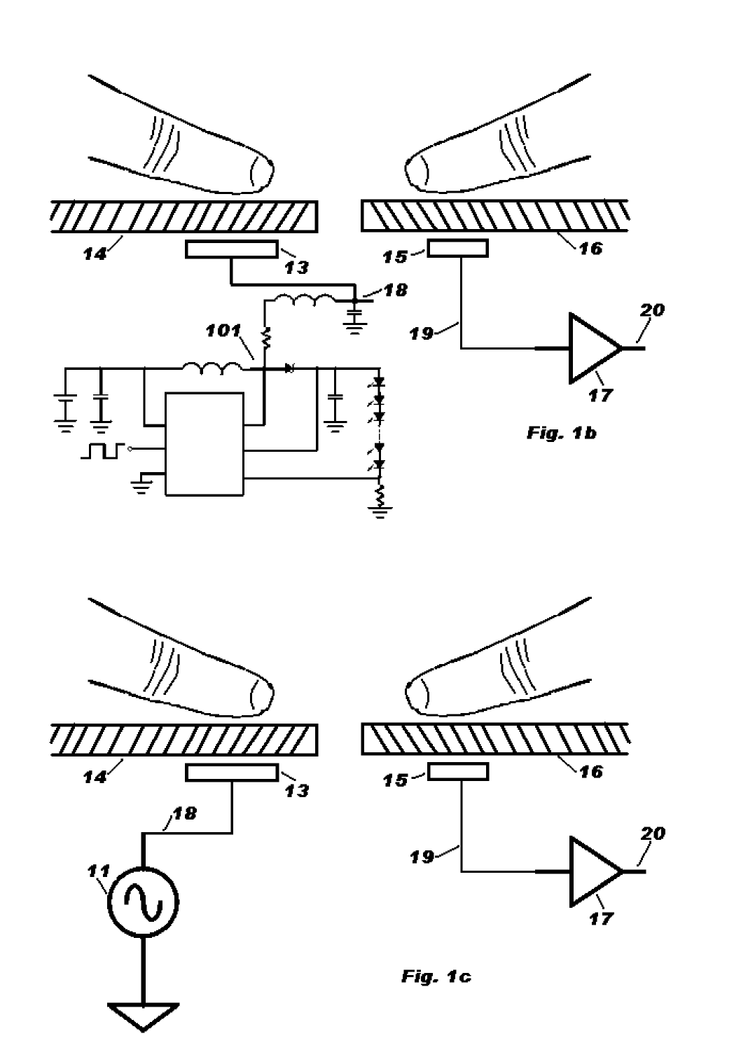

FIG. 2 is an electrical model of FIG. 1a. The capacitors 21 and 22 are the effective capacitance of the dielectric layers 14 and 16 in FIG. 1a respectively. The resistor 23 and logic gate 24 replace the sensing circuit 17 in FIG. 1a. The resistor 25 models the effective resistance of a human body. The capacitor 26 models the capacitance between the human body and the ground. Their typical values are shown in FIG. 2 as well.

The effective capacitances of both dielectric layers are calculated on the assumption that the dielectric layer has a thickness of 2 mm and the contact area between a finger and the dielectric layer is 100 mm². It is also assumed that the logic gate has a 5 p input capacitance. It can easily be shown that the sensed voltage at the sensed plate has a 6.6V peak when the signal 18 has a 400 v peak. This is sufficient to trigger a 5V logic gate. Resistor 23 is a pull-down resistor such that when a finger is not on top of the sensing electrode, the signal 19 is normally low. When a finger is on top of the sensing electrode, the maximum of signal 19 will exceed the logic high threshold and generate the control signal 20. Resistor 23 can be a pull-up resistor such that signal 19 is normally high.

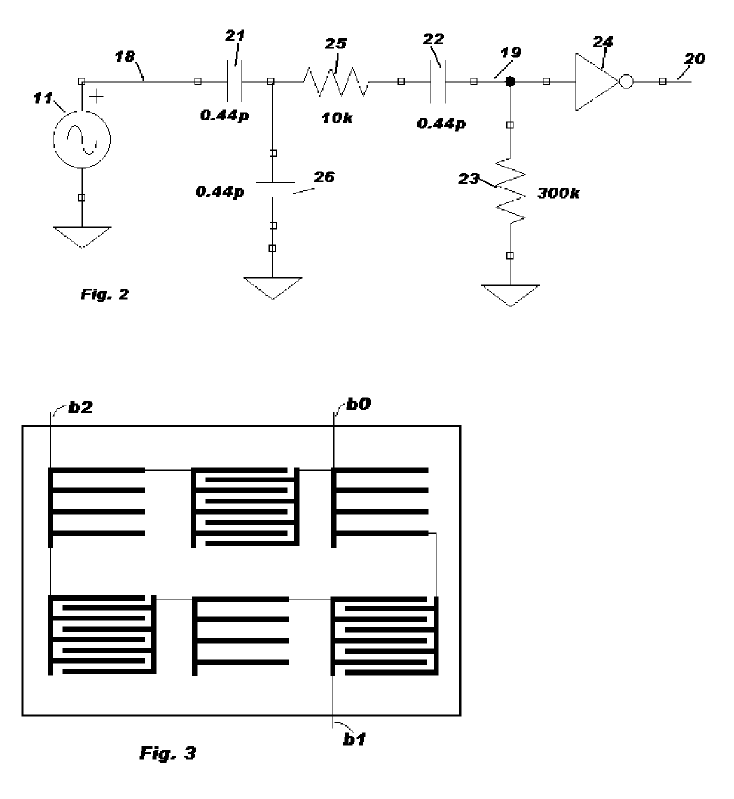

FIG. 3 illustrates the arrangement of multiple sensing electrodes into binary group and generates corresponding binary signals. The signals b0, b1 and b2 can be used to generate the 1st, 2nd and 3rd bit of a 3-bits binary signal respectively. For example, when a finger is on top of the upper left corner pattern of electrodes, the voltage level of b2 becomes high while the others remain low. This can be decoded as a binary 100 signal. When a finger is on top of the lower right corner pattern of electrodes, the voltage level of b1 and b0 become high while b2 remains low. This can be decoded as a binary 011 signal.

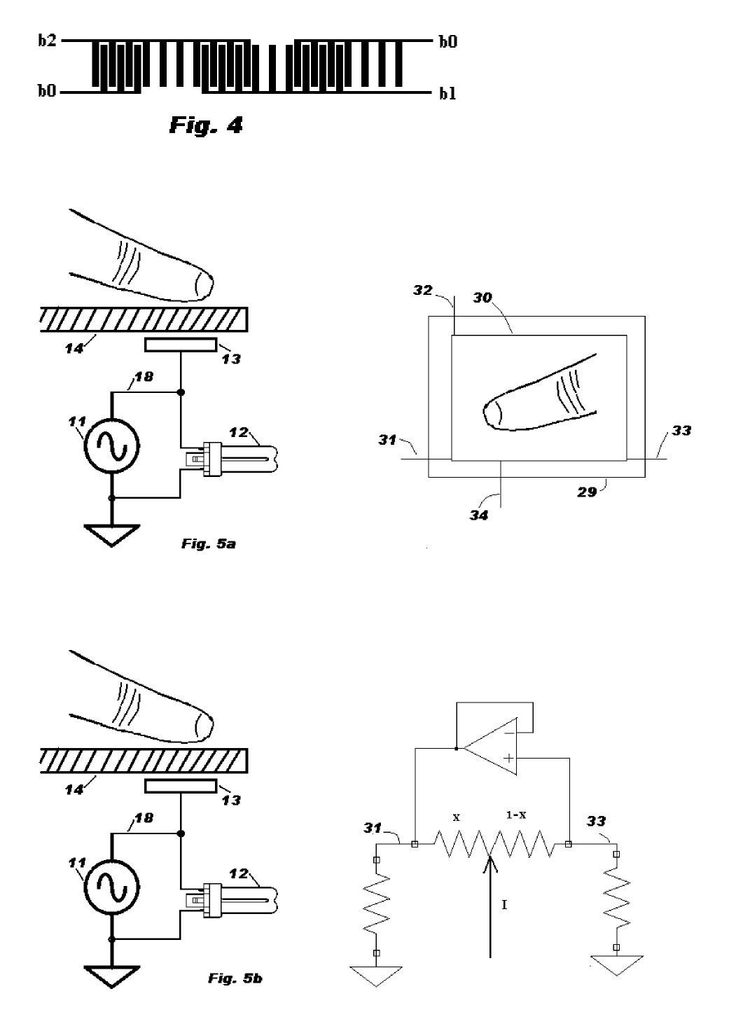

FIG. 4 illustrates still another pattern of electrodes. The signals b2, b1 and b0 can be used to generate the 3rd, 2nd and 1st bit of a 3-bits binary signal respectively. The patterns of the sensing electrodes are arranged into a control bar. Its operation principle is similar to the embodiment in FIG. 3. When a human finger is on top of the right end of the bar and then move to the left along the bar, the signal (b2,b1,b0) will be a sequence of binary bit patterns: 001,011,010,110,100,101. Thus by decoding the corresponding bit pattern, one may decide the 6 possible positions of the finger. The unique feature of these patterns is that adjacent wire patterns only generate a single bit change in the binary bit pattern.

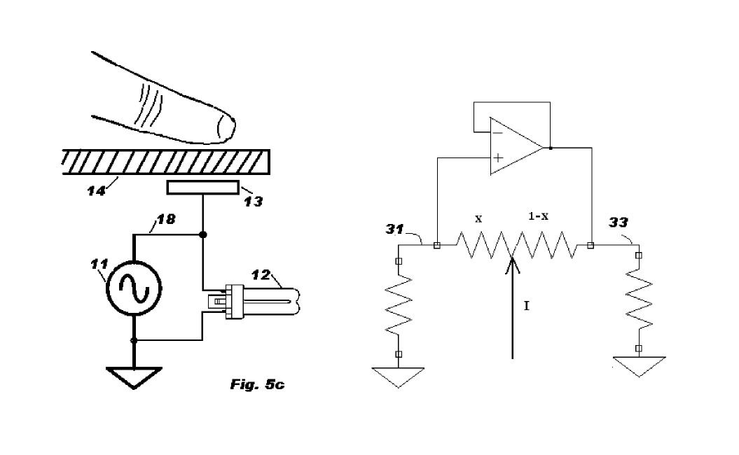

FIG. 5a illustrates another embodiment of the present invention when the sensing electrode 30 is a transparent and resistive surface, e.g. an ITO layer, patterned under the glass (or a PET film) 29. When a finger touches the glass (or PET film) 29, the signals 31-34 can be used to determine the x-y coordinate of the touch point. FIG. 5b and FIG. 5c illustrate how the x-y coordinate can be determined from signal 31 and 33 by using the principle taught by U.S. Pat. No. 4,680,430. The resistance x and 1−x model the distance of the touch point from the left and right hand side edge of the glass (or film) respectively. Let the voltage of signal 33 in FIG. 5b is C and that of signal 31 in FIG. 5c is A, a person who is skilled in the art may find that the coordinate x=C/(A+C). The y coordinate can be found by the same principle. The working principle of this embodiment is similar to that in U.S. Pat. No. 5,365,461. The major difference is that the human body is used to replace the stylus.

Since this invention measures the voltage instead of the capacitance, the measurement time is quick and robust. In comparison with other capacitive touch panel which require long integration time to do indirect measurement of the human capacitance, this invention is less sensitive to parasitic capacitance and interference from the LCD panel below. Furthermore, the present invention uses a single layer of ITO film to accomplish the task. In comparison with resistive touch panel, the expensive two layers panel is spared and the transparency of the panel is higher.

When the sensing electrode is placed on top of a LCD panel, it is plausible that the driving signal of the panel will be coupled to the sensing electrode capacitively. To eliminate the interference from the LCD panel, a differential amplifier can be employed to compare the signal from the sensing electrode with another untouched electrode which may receive the same level of interference from the LCD panel. Still another plausible solution is to disable the sensing electrode during the rising and falling edges of the driving signal of the LCD panel. Since the interference is coupled capacitively to the sensing electrode, the interference is strongest at the rising or falling edges of the interference signal. If the measurement is done at a time which is far away from the rising or falling edge, reliable measurement can be obtained.

Although the present invention has been described by way of exemplary embodiments on specify patterns of conductor, it should be understood that the present invention can be applied to other patterns. Changes and substitutions needed to use the present invention on other patterns may be made by those skilled in the art without departing from the scope of the present invention which is defined by the appended claims.

What is claimed is:

1. An input device which comprising:
a high voltage and high frequency AC source;
a sourcing terminal which connect to the AC source and capacitively coupled to the user;
an insulative substrate having a top and bottom side;
a conductive surface coating on the bottom side of the substrate;
means to detect a touch of the user on the top side of the substrate.

2. The input device according to claim 1, wherein the said conductive surface coating has a patterned region such that the said means to detect the user's touch further includes means to generate a binary signal which indicates the location of the touch above the patterned region.

3. The input device according to claim 1, wherein the said means to detect the user's touch further includes means to determine the location of touch above a non-patterned region of the said conductive surface coating.
